(19) United States
(12) Patent Application Publication
(10) Pub. No.: US 2025/0150932 A1
(43) Pub. Date: May 8, 2025

(54) PROVISIONING OF VEHICLE-MOUNTED RELAYS

(71) Applicant: QUALCOMM Incorporated, San Diego, CA (US)

(72) Inventors: Lenaig Genevieve CHAPONNIERE, La Jolla, CA (US); Hong CHENG, Basking Ridge, NJ (US); Francesco PICA, San Diego, CA (US); Sebastian SPEICHER, Wallisellen (CH); Haris ZISIMOPOULOS, London (GB)

(21) Appl. No.: 18/833,061

(22) PCT Filed: Feb. 10, 2023
(86) PCT No.: PCT/US2023/062392

§ 371 Date: Jul. 25, 2024

(30) Foreign Application Priority Data
Mar. 28, 2022 (GR) 20220100269

(51) Int. Cl. H04W 40/22; H04L 41/0853; H04L 47/28; H04W 24/02

(52) U.S. Cl. CPC H04W 40/22; H04L 41/0853; H04L 47/28; H04W 24/02

(57) ABSTRACT

Various aspects of the present disclosure generally relate to wireless communication. In some aspects, a wireless communication device may receive a vehicle-mounted relay (VMR) configuration, the VMR configuration including one or more operating parameters associated with performing communication relaying. The wireless communication device may perform communication relaying based at least in part on the one or more operating parameters indicated by the VMR configuration. Numerous other aspects are described.

### CROSS-REFERENCE TO RELATED APPLICATION

This patent application claims priority to Greece Patent Application Serial No. 20220100269, filed on Mar. 28, 2022, entitled “PROVISIONING OF VEHICLE-MOUNTED RELAYS,” and assigned to the assignee hereof. The disclosure of the prior application is considered part of and is incorporated by reference into this patent application.

### FIELD OF THE DISCLOSURE

Aspects of the present disclosure generally relate to wireless communication and to techniques and apparatuses for provisioning of vehicle-mounted relays.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more base stations that support communication for a user equipment (UE) or multiple UEs. A UE may communicate with a base station via downlink communications and uplink communications. “Downlink” (or “DL”) refers to a communication link from the base station to the UE, and “uplink” (or “UL”) refers to a communication link from the UE to the base station.

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a wireless communication device. The method may include receiving a vehicle-mounted relay (VMR) configuration, the VMR configuration including one or more operating parameters associated with performing communication relaying. The method may include performing communication relaying based at least in part on the one or more operating parameters indicated by the VMR configuration.

Some aspects described herein relate to a method of wireless communication performed by a network entity. The method may include receiving an indication to transmit a VMR configuration for reception by a wireless communication device. The method may include transmitting the VMR configuration for reception by the wireless communication device based at least in part on the indication, where the VMR configuration includes one or more operating parameters associated with performing communication relaying.

Some aspects described herein relate to a wireless communication device for wireless communication. The wireless communication device may include a memory and one or more processors coupled to the memory. The one or more processors may be configured to receive a VMR configuration, the VMR configuration including one or more operating parameters associated with performing communication relaying. The one or more processors may be configured to perform communication relaying based at least in part on the one or more operating parameters indicated by the VMR configuration.

Some aspects described herein relate to a network entity for wireless communication. The network entity may include a memory and one or more processors coupled to the memory. The one or more processors may be configured to receive an indication to transmit a VMR configuration for reception by a wireless communication device. The one or more processors may be configured to transmit the VMR configuration for reception by the wireless communication device based at least in part on the indication.

Some aspects described herein relate to a non-transitory computer-readable medium that stores a set of instructions for wireless communication by a wireless communication device. The set of instructions, when executed by one or more processors of the wireless communication device, may cause the wireless communication device to receive a VMR configuration, the VMR configuration including one or more operating parameters associated with performing communication relaying. The set of instructions, when executed by one or more processors of the wireless communication device, may cause the wireless communication device to perform communication relaying based at least in part on the one or more operating parameters indicated by the VMR configuration.

Some aspects described herein relate to a non-transitory computer-readable medium that stores a set of instructions for wireless communication by a network entity. The set of instructions, when executed by one or more processors of the network entity, may cause the network entity to receive an indication to transmit a VMR configuration for reception by a wireless communication device. The set of instructions, when executed by one or more processors of the network entity, may cause the network entity to transmit the VMR configuration for reception by the wireless communication device based at least in part on the indication.

Some aspects described herein relate to an apparatus for wireless communication. The apparatus may include means for receiving a VMR configuration, the VMR configuration including one or more operating parameters associated with performing communication relaying. The apparatus may include means for performing communication relaying based at least in part on the one or more operating parameters indicated by the VMR configuration.

Some aspects described herein relate to an apparatus for wireless communication. The apparatus may include means for receiving an indication to transmit a VMR configuration for reception by a wireless communication device. The apparatus may include means for transmitting the VMR configuration for reception by the wireless communication device based at least in part on the indication, where the VMR configuration includes one or more operating parameters associated with performing communication relaying.

Aspects generally include a method, apparatus, system, computer program product, non-transitory computer-readable medium, user equipment, base station, wireless communication device, and/or processing system as substantially described herein with reference to and as illustrated by the drawings, specification, and appendix.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a user equipment (UE) in a wireless network, in accordance with the present disclosure.

FIGS. 3 and 4 are diagrams illustrating examples of a relay that relays communications between wireless communication devices, in accordance with the present disclosure.

FIG. 5 is a diagram of an example associated with provisioning of vehicle-mounted relays (VMRs), in accordance with various aspects of the present disclosure.

FIG. 6 is a diagram of an example of an architecture for enabling provisioning of VMRs, in accordance with various aspects of the present disclosure.

FIGS. 7 and 8 are diagrams illustrating example processes associated with provisioning of VMRs, in accordance with the present disclosure.

FIGS. 9 and 10 are diagrams of example apparatuses for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

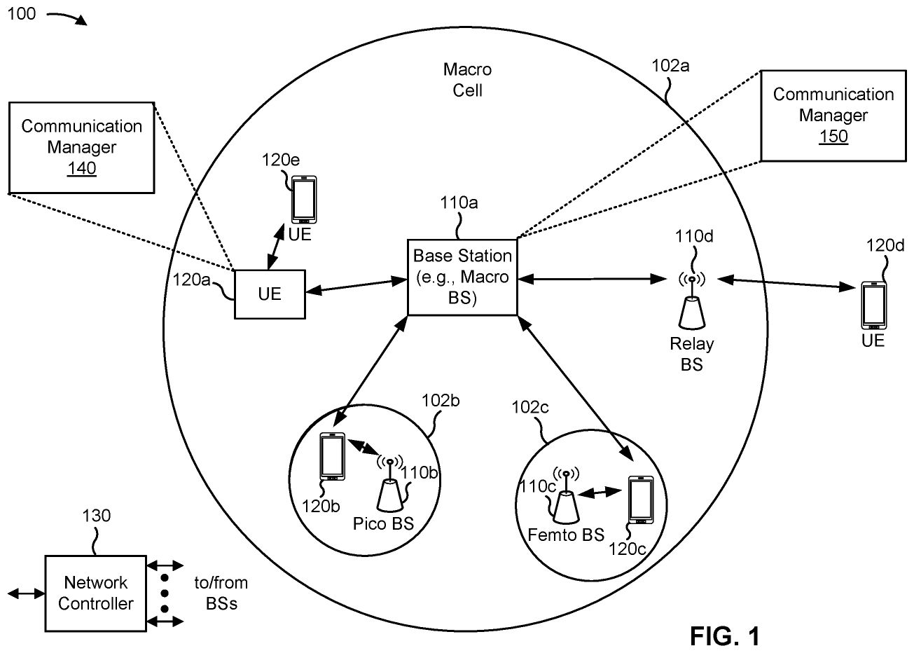

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more base stations 110 (shown as a BS 110a, a BS 110b, a BS 110c, and a BS 110d), a user equipment (UE) 120 or multiple UEs 120 (shown as a UE 120a, a UE 120b, a UE 120c, a UE 120d, and a UE 120e), and/or other network entities. A base station 110 is an entity that communicates with UEs 120. A base station 110 (sometimes referred to as a BS) may include, for example, an NR base station, an LTE base station, a Node B, an eNB (e.g., in 4G), a gNB (e.g., in 5G), an access point, and/or a transmission reception point (TRP). Each base station 110 may provide communication coverage for a particular geographic area. In the Third Generation Partnership Project (3GPP), the term “cell” can refer to a coverage area of a base station 110 and/or a base station subsystem serving this coverage area, depending on the context in which the term is used.

A base station 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (e.g., a home) and may allow restricted access by UEs 120 having association with the femto cell (e.g., UEs 120 in a closed subscriber group (CSG)). A base station 110 for a macro cell may be referred to as a macro base station. A base station 110 for a pico cell may be referred to as a pico base station. A base station 110 for a femto cell may be referred to as a femto base station or an in-home base station. In the example shown in FIG. 1, the BS 110a may be a macro base station for a macro cell 102a, the BS 110b may be a pico base station for a pico cell 102b, and the BS 110c may be a femto base station for a femto cell 102c. A base station may support one or multiple (e.g., three) cells.

Deployment of communication systems, such as 5G New Radio (NR) systems, may be arranged in multiple manners with various components or constituent parts. In a 5G NR system, or network, a network node, a network entity, a mobility element of a network, a radio access network (RAN) node, a core network node, a network element, a base station, or a network equipment may be implemented in an aggregated or disaggregated architecture. For example, a base station (such as a Node B (NB), evolved NB (eNB), NR base station (BS), 5G NB, gNodeB (gNB), access point (AP), transmit receive point (TRP), or cell), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station may be configured to utilize a radio protocol stack that is physically or logically integrated within a single RAN node (for example, within a single device or unit). A disaggregated base station may be configured to utilize a protocol stack that is physically or logically distributed among two or more units (such as one or more CUs, one or more DUs, or one or more RUs). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU, and RU also may be implemented as virtual units (e.g., a virtual central unit (VCU), a virtual distributed unit (VDU), or a virtual radio unit (VRU)).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that may be individually deployed. A disaggregated base station may include functionality implemented across two or more units at various physical locations, as well as functionality implemented for at least one unit virtually, which may enable flexibility in network design. The various units of the disaggregated base station may be configured for wired or wireless communication with at least one other unit of the disaggregated base station.

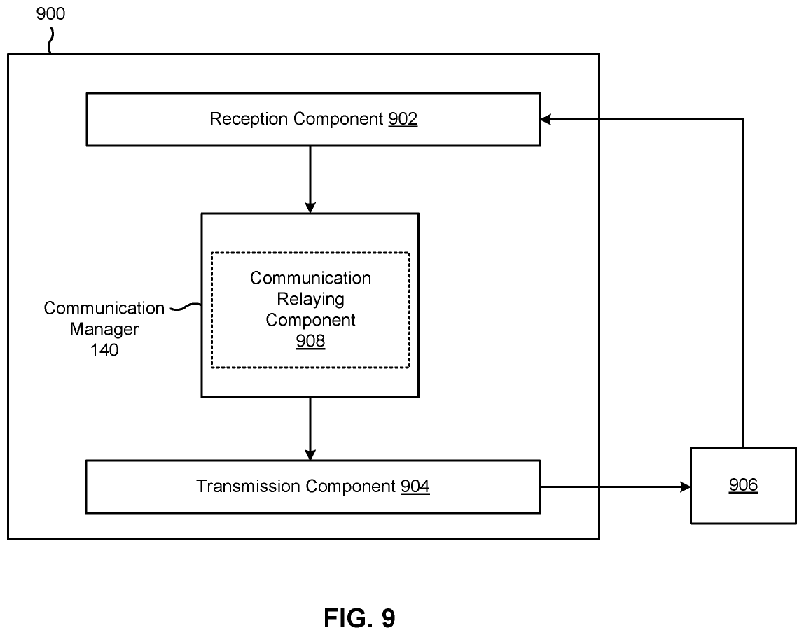

In some aspects, the term “base station” (e.g., the base station 110) or “network node” or “network entity” may refer to an aggregated base station, a disaggregated base station (e.g., described in connection with FIG. 9), an integrated access and backhaul (IAB) node, a relay node, and/or one or more components thereof. For example, in some aspects, “base station,” “network node,” or “network entity” may refer to a central unit (CU), a distributed unit (DU), a radio unit (RU), a Near-Real Time (Near-RT) RAN Intelligent Controller (RIC), or a Non-Real Time (Non-RT) RIC, or a combination thereof. In some aspects, the term “base station,” “network node,” or “network entity” may refer to one device configured to perform one or more functions, such as those described herein in connection with the base station 110. In some aspects, the term “base station,” “network node,” or “network entity” may refer to a plurality of devices configured to perform the one or more functions. For example, in some distributed systems, each of a number of different devices (which may be located in the same geographic location or in different geographic locations) may be configured to perform at least a portion of a function, or to duplicate performance of at least a portion of the function, and the term “base station,” “network node,” or “network entity” may refer to any one or more of those different devices. In some aspects, the term “base station,” “network node,” or “network entity” may refer to one or more virtual base stations and/or one or more virtual base station functions. For example, in some aspects, two or more base station functions may be instantiated on a single device. In some aspects, the term “base station,” “network node,” or “network entity” may refer to one of the base station functions and not another. In this way, a single device may include more than one base station.

In some examples, a cell may not necessarily be stationary, and the geographic area of the cell may move according to the location of a base station 110 that is mobile (e.g., a mobile base station). In some examples, the base stations 110 may be interconnected to one another and/or to one or more other base stations 110 or network nodes (not shown) in the wireless network 100 through various types of backhaul interfaces, such as a direct physical connection or a virtual network, using any suitable transport network.

The wireless network 100 may include one or more relay stations. A relay station is an entity that can receive a transmission of data from an upstream station (e.g., a base station 110 or a UE 120) and send a transmission of the data to a downstream station (e.g., a UE 120 or a base station 110). A relay station may be a UE 120 that can relay transmissions for other UEs 120. In the example shown in FIG. 1, the BS 110d (e.g., a relay base station) may communicate with the BS 110a (e.g., a macro base station) and the UE 120d in order to facilitate communication between the BS 110a and the UE 120d. A base station 110 that relays communications may be referred to as a relay station, a relay base station, a relay, or the like.

The wireless network 100 may be a heterogeneous network that includes base stations 110 of different types, such as macro base stations, pico base stations, femto base stations, relay base stations, or the like. These different types of base stations 110 may have different transmit power levels, different coverage areas, and/or different impacts on interference in the wireless network 100. For example, macro base stations may have a high transmit power level (e.g., 5 to 40 watts) whereas pico base stations, femto base stations, and relay base stations may have lower transmit power levels (e.g., 0.1 to 2 watts).

A network controller 130 may couple to or communicate with a set of base stations 110 and may provide coordination and control for these base stations 110. The network controller 130 may communicate with the base stations 110 via a backhaul communication link. The base stations 110 may communicate with one another directly or indirectly via a wireless or wireline backhaul communication link.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, and/or any other suitable device that is configured to communicate via a wireless medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a base station, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the base station 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHZ) and FR2 (24.25 GHz-52.6 GHz). It should be understood that although a portion of FR1 is greater than 6 GHZ, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHZ-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHZ-71 GHZ), FR4 (52.6 GHZ-114.25 GHz), and FR5 (114.25 GHZ-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHZ, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, a wireless communication device (e.g., a UE 120) may include a communication manager 140. As described in more detail elsewhere herein, the communication manager 140 may receive a VMR configuration, the VMR configuration including one or more operating parameters associated with performing communication relaying; and perform communication relaying based at least in part on the one or more operating parameters indicated by the VMR configuration. Additionally, or alternatively, the communication manager 140 may perform one or more other operations described herein.

In some aspects, a network entity (e.g., a base station 110) may include a communication manager 150. As described in more detail elsewhere herein, the communication manager 150 may receive an indication to transmit a VMR configuration for reception by a wireless communication device; and transmit the VMR configuration for reception by the wireless communication device based at least in part on the indication, wherein the VMR configuration includes one or more operating parameters associated with performing communication relaying. Additionally, or alternatively, the communication manager 150 may perform one or more other operations described herein.

As indicated above, FIG. 1 is provided as an example. Other examples may differ from what is described with regard to FIG. 1.

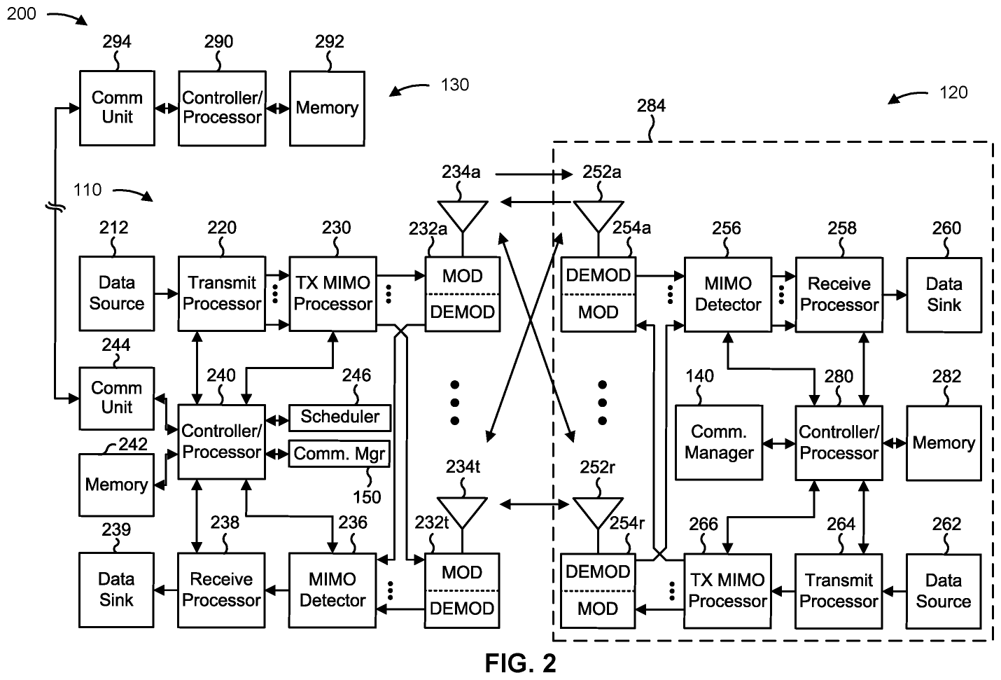

FIG. 2 is a diagram illustrating an example 200 of a base station 110 in communication with a UE 120 in a wireless network 100, in accordance with the present disclosure. The base station 110 may be equipped with a set of antennas 234a through 234t, such as T antennas (T≥1). The UE 120 may be equipped with a set of antennas 252a through 252r, such as R antennas (R≥1).

At the base station 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The base station 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the base station 110 and/or other base stations 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the base station 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

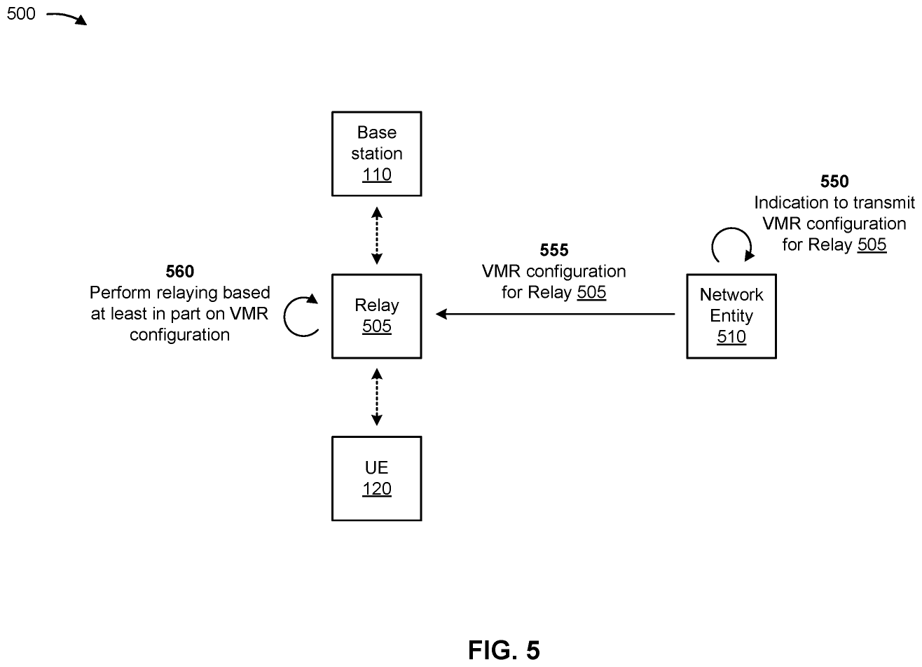

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the base station 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 5-10). At the base station 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The base station 110 may include a communication unit 244 and may communicate with the network controller 130 via the communication unit 244. The base station 110 may include a scheduler 246 to schedule one or more UEs 120 for downlink and/or uplink communications. In some examples, the modem 232 of the base station 110 may include a modulator and a demodulator. In some examples, the base station 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 5-10).

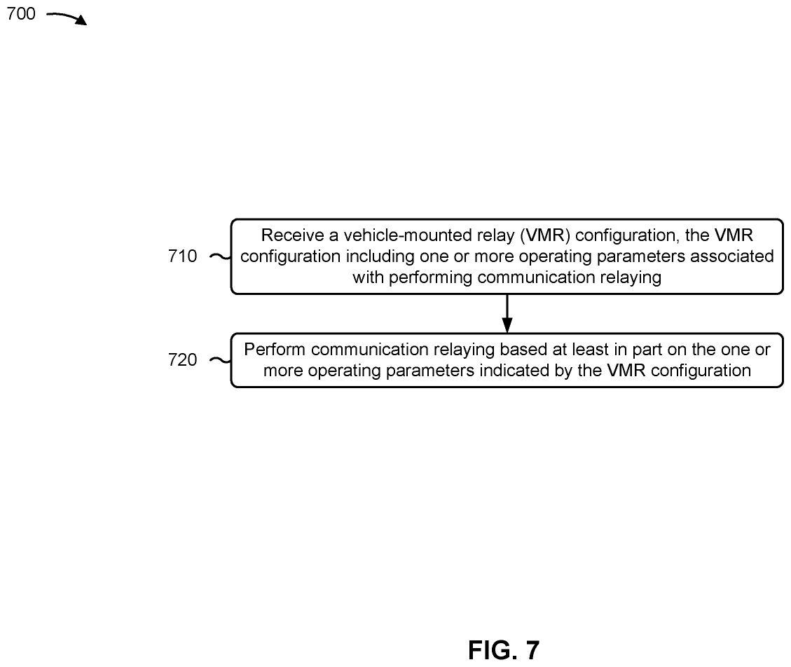

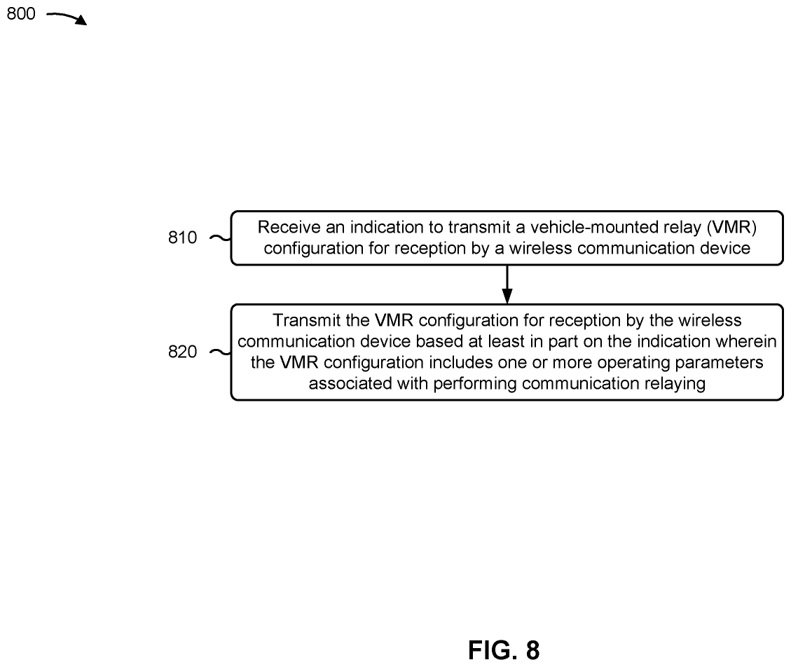

The controller/processor 240 of the base station 110, the controller/processor 280 of the UE 120, and/or any other component(s) of FIG. 2 may perform one or more techniques associated with provisioning VMRs, as described in more detail elsewhere herein. For example, the controller/processor 240 of the base station 110, the controller/processor 280 of the UE 120, and/or any other component(s) of FIG. 2 may perform or direct operations of, for example, process 700 of FIG. 7, process 800 of FIG. 8, and/or other processes as described herein. The memory 242 and the memory 282 may store data and program codes for the base station 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, process700 of FIG. 7, process 800 of FIG. 8, and/or other processes as described herein. In some examples, executing instructions may include running the instructions, converting the instructions, compiling the instructions, and/or interpreting the instructions, among other examples.

In some aspects, a wireless communication device (e.g., a UE 120) includes means for receiving a VMR configuration, the VMR configuration including one or more operating parameters associated with performing communication relaying; and/or means for performing communication relaying based at least in part on the one or more operating parameters indicated by the VMR configuration. In some aspects, the means for the wireless communication device to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, a network entity (e.g., a base station 110) includes means for receiving an indication to transmit a VMR configuration for reception by a wireless communication device; and/or means for transmitting the VMR configuration for reception by the wireless communication device based at least in part on the indication, wherein the VMR configuration includes one or more operating parameters associated with performing communication relaying. In some aspects, the means for the network entity to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

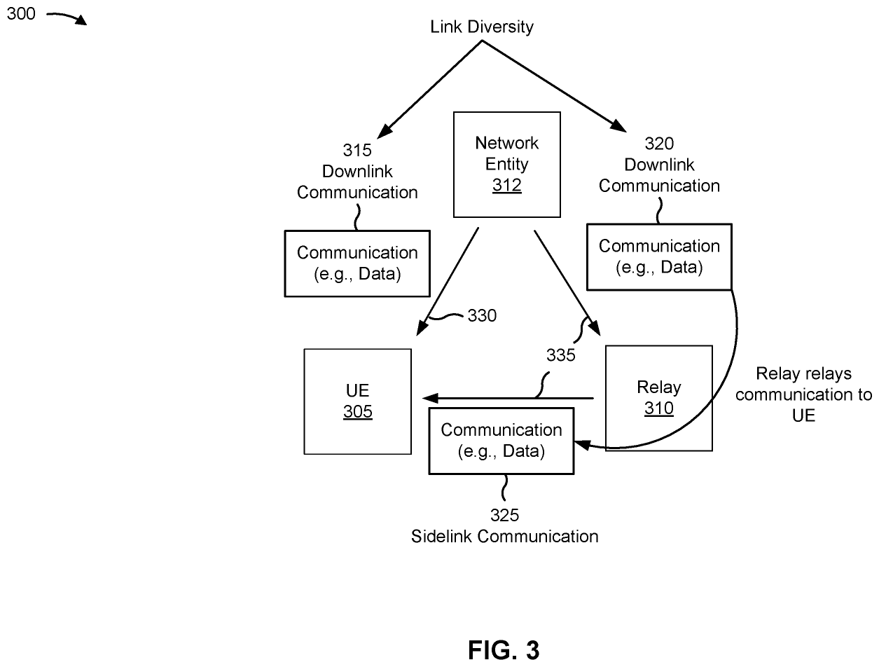

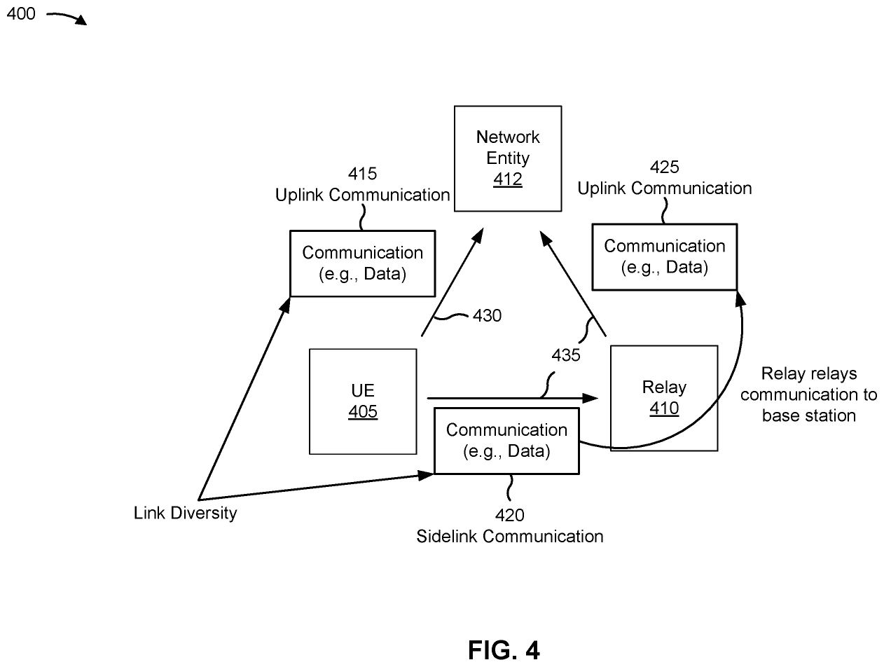

FIGS. 3 and 4 are diagram illustrating examples 300 and 400, respectively, of a relay that relays communications between wireless communication devices, in accordance with the present disclosure. As shown, example 300 includes a UE 305, a relay 310, and a network entity 312. In example 300, the UE 305 is an Rx UE, the relay 310 is a Tx relay (e.g., a Tx UE), and the network entity 312 is a base station 110. In some aspects, the UE 305 is a UE 120. In some aspects, the UE 305 may be referred to as a remote UE.

In some aspects, the relay 310 is another UE 120. Alternatively, in some aspects, the relay 310 is a base station 110. In some aspects, the relay 310 is a vehicle-mounted relay (VMR). For example, the relay 310 may be a relay mounted on an automobile (e.g., a taxi, an end-user automobile, or the like), a bus, a train, an aircraft (e.g., an airplane, a dirigible, an unmanned aerial vehicle (UAV), or the like), a watercraft, or a bicycle, among other examples.

As shown in FIG. 3, the UE 305 may receive a communication (e.g., data and/or control information) directly from the network entity 312 as a downlink communication 315. Additionally, or alternatively, the UE 305 may receive a communication (e.g., data and/or control information) indirectly from the network entity 312 via the relay 310. For example, the network entity 312 may transmit the communication to the relay 310 as a downlink communication 320, and the relay 310 may relay (e.g., forward or transmit) the communication to the UE 305 as a sidelink communication 325.

In some aspects, the UE 305 may communicate directly with the network entity 312 via a direct link 330. For example, the downlink communication 315 may be transmitted via the direct link 330. A communication transmitted via the direct link 330 between the UE 305 and the network entity 312 (e.g., in the downlink communication 315) does not pass through and is not relayed by the relay 310. In some aspects, the UE 305 may communicate indirectly with the network entity 312 via an indirect link 335. For example, the downlink communication 320 and the sidelink communication 325 may be transmitted via different segments of the indirect link 335. A communication transmitted via the indirect link 335 between the UE 305 and the network entity 312 (e.g., in the downlink communication 320 and the sidelink communication 325) passes through and is relayed by the relay 310. Using the communication scheme shown in FIG. 3 may improve network performance and increase reliability by providing the UE 305 with link diversity for communicating with the network entity 312.

In some cases, the UE 305 may receive a communication (e.g., the same communication) from the network entity 312 via both the direct link 330 and the indirect link 335. In other cases, the network entity 312 may select one of the links (e.g., either the direct link 330 or the indirect link 335), and may transmit a communication to the UE 305 using only the selected link. Alternatively, the network entity 312 may receive an indication of one of the links (e.g., either the direct link 330 or the indirect link 335), and may transmit a communication to the UE 305 using only the indicated link. The indication may be transmitted by the UE 305 and/or the relay 310. In some aspects, such selection and/or indication may be based at least in part on channel conditions and/or link reliability.

As shown, example 400 includes a UE 405, a relay 410, and a network entity 412. In example 400, the UE 405 is a Tx UE, the relay 410 is an Rx relay (e.g., an Rx UE), and the network entity 412 is a base station 110. In some aspects, the UE 405 is one UE 120. In some aspects, the UE 405 may be referred to as a remote UE.

In some aspects, the relay 410 is another UE 120. Alternatively, in some aspects, the relay 310 is a base station 110. In some aspects, the relay 410 is a VMR. For example, the relay 310 may be a relay mounted on an automobile (e.g., a taxi, an end-user automobile, or the like), a bus, a train, an aircraft (e.g., an airplane, a dirigible, an unmanned aerial vehicle (UAV), or the like), a watercraft, or a bicycle, among other examples.

As shown in FIG. 4, the UE 405 may transmit a communication (e.g., data and/or control information) directly to the network entity 412 as an uplink communication 415. Additionally, or alternatively, the UE 405 may transmit a communication (e.g., data and/or control information) indirectly to the network entity 412 via the relay 410. For example, the UE 405 may transmit the communication to the relay 410 as a sidelink communication 420, and the relay 410 may relay (e.g., forward or transmit) the communication to the network entity 412 as an uplink communication 425.

In some aspects, the UE 405 may communicate directly with the network entity 412 via a direct link 430. For example, the uplink communication 415 may be transmitted via the direct link 430. A communication transmitted via the direct link 430 between the UE 405 and the network entity 412 (e.g., in the uplink communication 415) does not pass through and is not relayed by the relay 410. In some aspects, the UE 405 may communicate indirectly with the network entity 412 via an indirect link 435. For example, the sidelink communication 420 and the uplink communication 425 may be transmitted via different segments of the indirect link 435. A communication transmitted via the indirect link 435 between the UE 405 and the network entity 412 (e.g., in the sidelink communication 420 and the uplink communication 425) passes through and is relayed by the relay 410.

Using the communication scheme shown in FIG. 4 may improve network performance and increase reliability by providing the UE 405 with link diversity for communicating with the network entity 412. For millimeter wave (e.g., frequency range 2, or FR2) communications, which are susceptible to link blockage and link impairment, this link diversity may improve reliability and prevent multiple retransmissions of data that may otherwise be retransmitted in order to achieve a successful communication. However, techniques described herein are not limited to millimeter wave communications, and may be used for sub-6 gigahertz (e.g., frequency range 1, or FR1) communications.

In some cases, the UE 405 may transmit a communication (e.g., the same communication) to the network entity 412 via both the direct link 430 and the indirect link 435. In other cases, the UE 405 may select one of the links (e.g., either the direct link 430 or the indirect link 435), and may transmit a communication to the network entity 412 using only the selected link. Alternatively, the UE 405 may receive an indication of one of the links (e.g., either the direct link 430 or the indirect link 435), and may transmit a communication to the network entity 412 using only the indicated link. The indication may be transmitted by the network entity 412 and/or the relay 410. In some aspects, such selection and/or indication may be based at least in part on channel conditions and/or link reliability.

In some aspects, relay 310/410 or a network entity 312/412 may perform one or more operations associated with provisioning of VMRs, as described herein. For example, in some aspects, a relay 310/410 may receive a VMR configuration and perform communication relaying based at least in part on the VMR configuration, as described herein. As another example, in some aspects, a network entity 312/412 may receive an indication to transmit a VMR configuration for reception by a relay 310/410, and may transmit the VMR for reception by the relay 310/410, as described herein.

As indicated above, FIGS. 3 and 4 are provided as examples. Other examples may differ from what is described with respect to FIGS. 3 and 4.

A wireless communication system may utilize relays to enhance coverage of a network or extend capacity of the network. In some cases, a relay may be mounted on a vehicle such that the relay moves with the vehicle (rather than being stationary). Such a relay is referred to as a vehicle-mounted relay (VMR). In some cases, a vehicle on which a VMR is mounted may be a vehicle with a known or predictable path (e.g., a bus, a train, or the like), or a vehicle with a variable or unpredictable path (e.g., a taxi, an automobile, or the like). VMRs can be particularly useful to facilitate communication relaying in, for example, an urban environment. In general, a VMR may receive coverage from a stationary network entity (e.g., a stationary base station, a donor base station, or the like), and may provide coverage to wireless communication devices (e.g., UEs) in the vicinity of the VMR.

Unlike in a network in which base stations are fixed and positioned based on network planning, VMRs may be moving at a given point in time. Further, a characteristic of movement (e.g., a location at a particular time, a speed, a location at a future time, or the like) of the vehicle on which a given VMR is mounted may or may not be known or predictable. For example, a characteristic of movement of a VMR mounted on a train may be known or predictable, while a characteristic of movement of a VMR mounted on an end-user automobile may be variable or unpredictable. Given the mobile nature of VMRs and the variance in predictability of movement, it is desirable for a network to be capable of configuring and controlling operation of a given relay for a number of reasons.

One reason that configuration and control of relay operation is desirable is to avoid having a VMR perform communication relaying while at a location at which the relay is not permitted to emit. Thus, it may be beneficial for the network to be able to apply a geography-based permission or restriction to the operation of a given VMR.

Another reason that configuration and control of relay operation is desirable is to avoid issues caused by the speed of a VMR. For example, in an urban area, a VMR providing coverage to UEs in a vicinity of the VMR should provide communication relaying only while moving at a relatively low speed so as to avoid frequent handovers and reduce a likelihood of radio link failures. Conversely, a VMR mounted to a vehicle that moves at a relatively high speed (e.g., a high speed train) should stop providing communication relaying operating when the vehicle stops or begins moving at a relatively low speed (e.g., as a train enters a train station), to avoid interfering with coverage of fixed cells in the area in which the VMR is stopped or is moving at the relatively low speed. Thus, it may be beneficial for the network to be able to apply a speed-based permission or restriction to the operation of a given VMR.

Another reason that configuration and control of relay operation is desirable is to enable an increased network capacity in an efficient manner. For example, a network may need to increase capacity only during a particular time window (e.g., during peak hours on a given day). Thus, it may be beneficial for the network to be able to apply a time-based permission or restriction to the operation of a given VMR.

Another reason that configuration and control of relay operation is desirable is to control operation of the VMR when roaming. For example, if a VMR roams into coverage of another network (e.g., a non-home network), then the VMR should continue to provide communication relaying only if there is a service level agreement (SLA) between the home network of the VMR and the visited network. Thus, it may be beneficial for the network to be able to apply a subscription-based permission or restriction to the operation of a given VMR.

Some techniques and apparatuses described herein enable provisioning of VMRs. In some aspects, a network entity may receive an indication to transmit a VMR configuration for reception by a wireless communication device (e.g., a VMR). The network entity may transmit, and the wireless communication device may receive, the VMR configuration. In some aspects, the VMR configuration includes one or more operating parameters associated with performing communication relaying as performed by the wireless communication device. The wireless communication device may then perform communication relaying based at least in part on the one or more operating parameters indicated by the VMR configuration. In this way, operation of the wireless communication device may be configured or controlled in a manner that increases efficiency or improves performance of network operation. Additional details are described below.

FIG. 5 is a diagram of an example 500 associated with provisioning of VMRs, in accordance with various aspects of the present disclosure. As shown in FIG. 5, example 500 includes communication between a relay 505 and a network entity 510. In some aspects, the relay 505 may be used to provide communication relaying for communications between the UE 120 and the base station 110. In some aspects, the relay 505 may correspond to one or more of a UE 120, a base station 110, a relay 310, or a relay 410. In some aspects, the network entity 510 may correspond to one or more of a base station 110, a network entity 312, or a network entity 412. In some aspects, the relay 505, the network entity 510, the base station 110, and the UE 120 may be included in a wireless network, such as wireless network 100. In some aspects, the relay 505, the network entity 510, the base station 110, and the UE 120 may communicate via one or more wireless links, such as an uplink, a downlink, or a sidelink.

As shown by reference 550, the network entity 510 may receive an indication to transmit a VMR configuration for reception by the relay 505.

A VMR configuration is a configuration that includes one or more operating parameters associated with performing communication relaying. That is, the VMR configuration is a configuration that includes one or more parameters based at least in part on which the relay 505 is to perform communication relaying.

In some aspects, the one or more operating parameters include a geography-based operating parameter. For example, as noted above, relay operation may permitted within one or more geographic areas or, similarly, may be forbidden within one or more geographic areas. Thus, in some aspects, the geography-based operating parameter may indicate one or more areas in which the relay 505 is permitted to perform communication relaying. Additionally, or alternatively, the geography-based parameter may indicate one or more geographic areas in which the relay is forbidden from performing communication relaying. In some aspects, a given geographic area indicated by the geography-based parameter may be defined by a list of coordinates, where each coordinate corresponds to a summit of a polygon that defines the geographic area.

Additionally, or alternatively, the one or more operating parameters may include a subscription-based operating parameter. In some aspects, the subscription-based operating parameter may indicate one or more non-home networks (e.g., one or more non-home public land mobile networks (PLMNs)) in which the relay 505 is permitted to perform communication relaying (e.g., when an SLA is in place between the home network of the relay 505 and the one or more non-home networks). Additionally, or alternatively, the subscription-based parameter may indicate one or more non-home networks (e.g., one or more non-home PLMNs) in which the relay 505 is forbidden from performing communication relaying (e.g., when no SLA is in place between the home network of the relay 505 and the one or more non-home networks).

Additionally, or alternatively, the one or more operating parameters include a time-based operating parameter. In some aspects, the time-based operating parameter may indicate one or more time windows during which the relay 505 is to perform communication relaying (e.g., to enable the network to increase capacity during peak hours). Additionally, or alternatively, the time-based operating parameter may indicate one or more time windows during which the relay 505 is not to perform communication relaying (e.g., to prevent unnecessary capacity increases during off-peak hours).

Additionally, or alternatively, the one or more operating parameters may include a speed-based operating parameter. In some aspects, the speed-based operating parameter may indicate one or more threshold speeds associated with relay operating of the relay 505. A threshold speed may be, for example, a speed at or above which the relay 505 is permitted to perform communication relaying, a speed at or above which the relay 505 is forbidden from performing communication relaying, a speed at or below which the relay 505 is permitted to perform communication relaying, a speed at or below which the relay 505 is forbidden from performing communication relaying, or the like. In some aspects, the speed threshold can be zero, in which case the relay 505 may only operate when the vehicle to which the relay 505 is mounted is not moving. In some aspects, the speed-based operating parameter may indicate a range of speeds associated with relay operation of the relay 505. The range of speeds may be, for example, a range of speeds within which the relay 505 is permitted to perform communication relaying or a range of speeds within which the relay 505 is forbidden from performing communication relaying.

In some aspects, the VMR configuration may include one or more types of parameters associated with provisioning the relay 505. For example, in some aspects, the VMR configuration may include one or more regional operations, administration, and maintenance (OAM) parameters, such as an OAM server address, a data network name (DNN), or single network slice selection assistance information (S-NSSAI), among other examples. In some aspects, the relay 505 may use the DNN or S-NSSAI in association with establishing a packet data unit (PDU) session toward an OAM server for provisioning. In some aspects, the regional OAM parameters may be used to enable configuration of the relay 505 on a per region basis (e.g., per PLMN, per geographic area, or the like) so that the relay 505 can be re-configured by a local server when the relay 505 moves to a different area.

As another example, in some aspects, the VMR configuration may include one or more radio configuration parameters, such as a frequency band, a cell identifier, or another type of radio parameter associated with provisioning the relay 505.

In some aspects, the indication received by the network entity 510 may be a request for the VMR configuration transmitted by the relay 505. For example, in some aspects, the relay 505 may transmit a request for the VMR configuration. Here, the network entity 510 may receive the request, and may transmit the VMR configuration in response to the request. In some aspects, the relay 505 may transmit the request by including a UE policy container in a registration request message. Additionally, or alternatively, the relay 505 may transmit the request by including a UE policy container in an uplink communication, such as an uplink non-access stratum (NAS) transport message.

As shown by reference 555, the network entity 510 may transmit the VMR configuration for reception by the relay 505 based at least in part on the indication and, as further indicated, the relay 505 may receive the VMR configuration transmitted by the network entity 510.

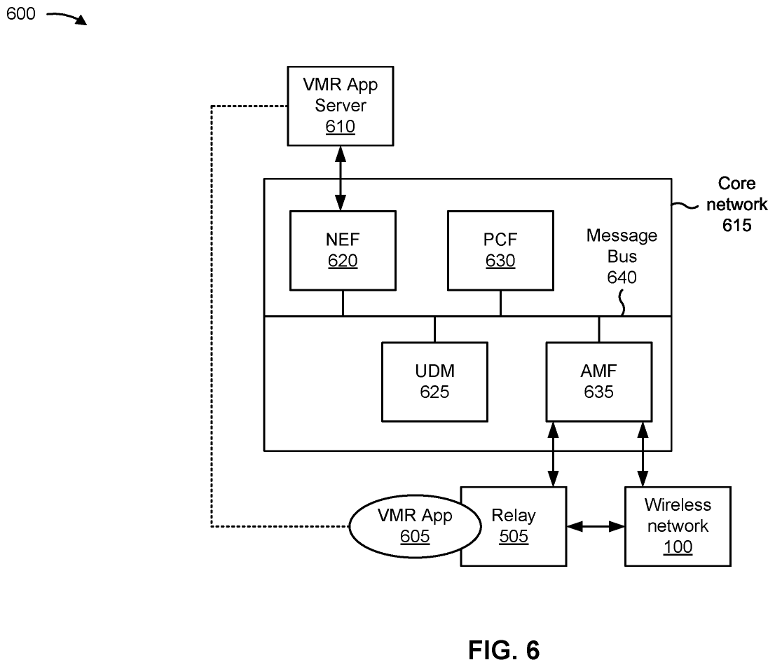

In some aspects, the network entity 510 may transmit, and the relay 505 may receive, the VMR configuration in a UE policy part IE. In some aspects, the UE policy part IE is included in a manage UE policy command that is carried in a downlink NAS transport message. In some aspects, a UE policy part type field of the UE policy part IE includes an indication that the UE policy part IE includes the VMR configuration. An architecture for enabling provisioning of the relay 505 in this manner is described in further detail below with respect to FIG. 6.

Alternatively, in some aspects, the network entity 510 may transmit, and the relay 505 may receive, the VMR configuration via an OAM PDU session. For example, the relay 505 may in some aspects establish an OAM PDU session based at least in part on one or more regional OAM parameters pre-configured on the relay 505, and the VMR configuration may be communicated via the OAM PDU session after establishment of the OAM PDU session. In some aspects, the one or more regional OAM parameters based at least in part on which the relay 505 establishes the OAM PDU session may include, for example, an OAM server address, a DNN, or S-NSSAI, among other examples.

As shown by reference 560, the relay 505 may perform communication relaying based at least in part on the one or more operating parameters indicated by the VMR configuration. For example, the relay 505 may receive the VMR configuration and may begin performing communication relaying of communications between the UE 120 and the base station 110 according to the one or more operating parameters (e.g., such that communication relaying is performed or not performed in an indicated geographic area, in an indicated non-home network, during an indicated time window, in accordance with an indicated speed threshold, or the like).

As indicated above, FIG. 5 is provided as an example. Other examples may differ from what is described with respect to FIG. 5.

FIG. 6 is a diagram of an example 600 of an architecture for enabling provisioning of VMRs, in accordance with various aspects of the present disclosure. As shown in FIG. 6, example 600 may include a relay 505 configured with a VMR application 605, a VMR application server 610, a core network 615, and a wireless communication network 100. Devices and/or networks of example 600 may interconnect via wired connections, wireless connections, or a combination thereof. In some aspects, an architecture such as that shown in example 600 provides network exposure function (NEF) services to enable communication between functions of core network 615 and the VMR application server 610.

As shown in FIG. 6, the core network 615 may include a number of functional elements. The functional elements may include, for example, a network exposure function (NEF) 620, a unified data management (UDM) component 625, a policy control function (PCF) 630, or an access and mobility management function (AMF) 635, among other examples. In some aspects, the core network 615 may include one or more other functional elements not shown in FIG. 6, such as a network slice selection function (NSSF), an authentication server function (AUSF), an application function (AF), a session management function (SMF), or a user plane function (UPF), among other examples. These functional elements may be communicatively connected via a message bus 640. Each of the functional elements may be implemented on one or more devices associated with a wireless telecommunications system. In some implementations, one or more of the functional elements may be implemented on physical devices, such as an access point, a base station, and/or a gateway, among other examples. In some implementations, one or more of the functional elements may be implemented on a computing device of a cloud computing environment.

The VMR application 605 is an application configured on the relay 505 that is used in association with configuring or controlling communication relaying as performed by the relay 505. In some aspects, the relay 505 may transmit a request for a VMR configuration via the VMR application 605. In some aspects, the relay 505 may transmit the request by including a UE policy container in a registration request message or an uplink NAS transport message.

The VMR application server 610 includes one or more devices associated with providing a VMR configuration to the core network 615 (e.g., for provisioning of one or more relays 505). For example, the VMR application server 610 may generate or determine a VMR configuration for the relay 505, and may provide the VMR configuration to the core network 615. In some aspects, the VMR application server may provide the VMR configuration via the NEF 620, and the NEF 620 may store the VMR configuration in the UDM 625. In some aspects, upon receiving a request transmitted by the relay 505 (e.g., via the VMR application 605), the PCF 630 retrieves the VMR configuration from the UDM 625 and provides the VMR configuration to the relay 505 via the AMF 635 and/or the network 100.

The wireless communication network 100 may support, for example, a cellular radio access technology (RAT). The network 100 may include one or more network entities (e.g., base transceiver stations, radio base stations, node Bs, eNodeBs (eNBs), gNodeBs (gNBs), base station subsystems, cellular sites, cellular towers, access points, transmit receive points (TRPs), radio access nodes, macrocell base stations, microcell base stations, picocell base stations, femtocell base stations, or similar types of devices) and other network entities that can support wireless communication among one or more wireless communication devices, such as one or more UEs (e.g., one or more UEs 120), one or more relays (e.g., one or more relays 310, one or more relays 410, one or more relays 505, or the like), or the like. The network 100 may transfer traffic between a given wireless communication device (e.g., using a cellular RAT), one or more base stations (e.g., using a wireless interface or a backhaul interface, such as a wired backhaul interface), and/or the core network 615. The network 100 may provide one or more cells that cover geographic areas.

In some aspects, the network 100 may perform scheduling and/or resource management for a wireless communication device covered by the network 100 (e.g., a UE 120 covered by a cell provided by the network 100). In some aspects, the network 100 may be controlled or coordinated by a network controller (e.g., network controller 130 of FIG. 1), which may perform load balancing and/or network-level configuration, among other examples. As described above in connection with FIG. 1, the network controller may communicate with the network 100 via a wireless or wireline backhaul. In some aspects, the network 100 may include a network controller, a self-organizing network (SON) module or component, or a similar module or component. Accordingly, the network 100 may perform network control, scheduling, and/or network management functions (e.g., for uplink, downlink, and/or sidelink communications of wireless communication device covered by the network 100).

In some aspects, the core network 615 may include an example functional architecture in which systems and/or methods described herein may be implemented. For example, the core network 615 may include an example architecture of a fifth generation (5G) next generation (NG) core network included in a 5G wireless telecommunications system. Although the example architecture of the core network 615 shown in FIG. 6 may be an example of a service-based architecture, in some aspects, the core network 615 may be implemented as a reference-point architecture and/or a 4G core network, among other examples.

The NEF 620 may include one or more devices that support exposure of capabilities and/or events in the wireless telecommunications system to help other entities in the wireless telecommunications system discover network services.

The UDM 625 (sometimes referred to as a unified data repository (UDR)) may include one or more devices that store user data and profiles in the wireless telecommunications system. In some aspects, the UDM 625 may be used for fixed access and/or mobile access, among other examples, in the core network 615.

The PCF 630 may include one or more devices that provide a policy framework that incorporates network slicing, roaming, packet processing, and/or mobility management, among other examples. In some aspects, the PCF 630 may include one or more UE route selection policy (URSP) rules used by an NSSF of the core network 615 to select network slice instances for a wireless communication device.

The AMF 635 may include one or more devices that act as a termination point for NAS signaling and/or mobility management, among other examples. In some aspects, the AMF 635 may request the NSSF of the core network 615 to select network slice instances for a wireless communication device (e.g., at least partially in response to a request for data service from the wireless communication device).

The message bus 640 may be a logical and/or physical communication structure for communication among the functional elements. Accordingly, the message bus 640 may permit communication between two or more functional elements of the core network 615, whether logically (e.g., using one or more application programming interfaces (APIs), among other examples) and/or physically (e.g., using one or more wired and/or wireless connections).

The number and arrangement of devices and networks shown in FIG. 6 are provided as an example. In practice, there may be additional devices and/or networks, fewer devices and/or networks, different devices and/or networks, or differently arranged devices and/or networks than those shown in FIG. 6. Furthermore, two or more devices shown in FIG. 6 may be implemented within a single device, or a single device shown in FIG. 6 may be implemented as multiple, distributed devices. Additionally, or alternatively, a set of devices (e.g., one or more devices) of example 600 may perform one or more functions described as being performed by another set of devices of example environment 600.

FIG. 7 is a diagram illustrating an example process 700 performed, for example, by a wireless communication device, in accordance with the present disclosure. Example process 700 is an example where the wireless communication device (e.g., a UE 120, a relay 310, a relay 410, a relay 505, or the like) performs operations associated with provisioning of vehicle-mounted relays.

As shown in FIG. 7, in some aspects, process 700 may include receiving a VMR configuration, the VMR configuration including one or more operating parameters associated with performing communication relaying (block 710). For example, the wireless communication device (e.g., using communication manager 140 and/or reception component 902, depicted in FIG. 9) may receive a VMR configuration, the VMR configuration including one or more operating parameters associated with performing communication relaying, as described above.

As further shown in FIG. 7, in some aspects, process 700 may include performing communication relaying based at least in part on the one or more operating parameters indicated by the VMR configuration (block 720). For example, the wireless communication device (e.g., using communication manager 140 and/or communication relaying component 908, depicted in FIG. 9) may perform communication relaying based at least in part on the one or more operating parameters indicated by the VMR configuration, as described above.

Process 700 may include additional aspects, such as any single aspect or any combination of aspects described below and/or in connection with one or more other processes described elsewhere herein.

In a first aspect, the one or more operating parameters include a geography-based operating parameter.

In a second aspect, alone or in combination with the first aspect, the one or more operating parameters include a subscription-based operating parameter.

In a third aspect, alone or in combination with one or more of the first and second aspects, the one or more operating parameters include a time-based operating parameter.

In a fourth aspect, alone or in combination with one or more of the first through third aspects, the one or more operating parameters include a speed-based operating parameter.

In a fifth aspect, alone or in combination with one or more of the first through fourth aspects, the VMR configuration further includes one or more regional OAM parameters.

In a sixth aspect, alone or in combination with one or more of the first through fifth aspects, the one or more regional OAM parameters include at least one of an OAM server address, a DNN, or S-NSSAI.

In a seventh aspect, alone or in combination with one or more of the first through sixth aspects, the VMR configuration further includes one or more radio configuration parameters.

In an eighth aspect, alone or in combination with one or more of the first through seventh aspects, the one or more radio configuration parameters include at least one of a frequency band or a cell identifier.

In a ninth aspect, alone or in combination with one or more of the first through eighth aspects, process 700 includes transmitting a request for the VMR configuration, wherein the VMR configuration is received after transmitting the request.

In a tenth aspect, alone or in combination with one or more of the first through ninth aspects, the request is transmitted by including a user equipment policy container in a registration request message.

In an eleventh aspect, alone or in combination with one or more of the first through tenth aspects, the request is transmitted by including a user equipment policy container in an uplink NAS transport message.

In a twelfth aspect, alone or in combination with one or more of the first through eleventh aspects, the VMR configuration is received in a UE policy part IE, wherein a UE policy part type field of the UE policy part IE includes an indication that the UE policy part IE includes the VMR configuration.

In a thirteenth aspect, alone or in combination with one or more of the first through twelfth aspects, the UE policy part IE is included in a manage UE policy command that is carried in a downlink NAS transport message.

In a fourteenth aspect, alone or in combination with one or more of the first through thirteenth aspects, process 700 includes establishing an OAM PDU session, wherein the VMR configuration is received via the OAM PDU session.

In a fifteenth aspect, alone or in combination with one or more of the first through fourteenth aspects, the OAM PDU session is established based at least in part on one or more regional OAM parameters pre-configured on the wireless communication device, wherein the one or more regional OAM parameters include at least one of an OAM server address, a DNN, or S-NSSAI.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram illustrating an example process 800 performed, for example, by a network entity, in accordance with the present disclosure. Example process 800 is an example where the network entity (e.g., a base station 110, a network entity 312, a network entity 412, a network entity 510, or the like) performs operations associated with provisioning of vehicle-mounted relays.

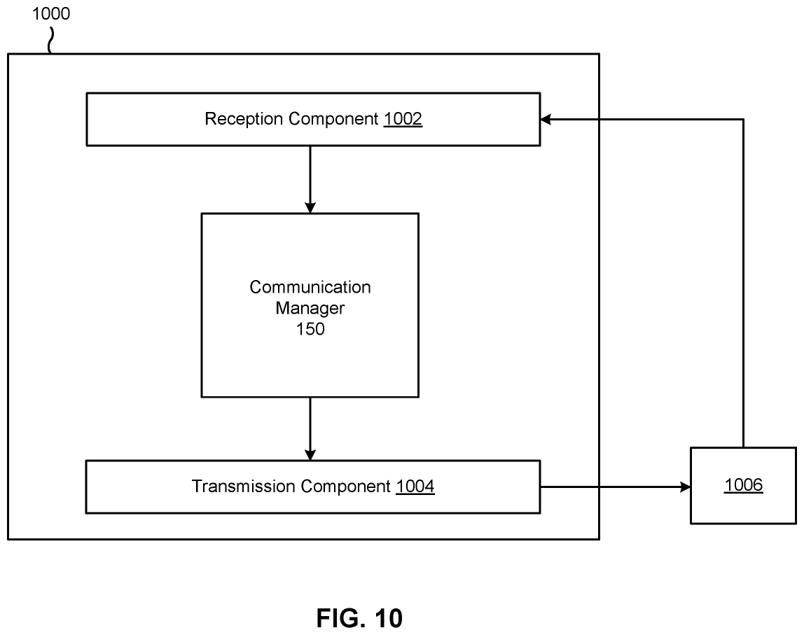

As shown in FIG. 8, in some aspects, process 800 may include receiving an indication to transmit a VMR configuration for reception by a wireless communication device (block 810). For example, the network entity (e.g., using communication manager 150 and/or reception component 1002, depicted in FIG. 10) may receive an indication to transmit a VMR configuration for reception by a wireless communication device, as described above.

As further shown in FIG. 8, in some aspects, process 800 may include transmitting the VMR configuration for reception by the wireless communication device based at least in part on the indication, wherein the VMR configuration includes one or more operating parameters associated with performing communication relaying (block 820). For example, the network entity (e.g., using communication manager 150 and/or transmission component 1004, depicted in FIG. 10) may transmit the VMR configuration for reception by the wireless communication device based at least in part on the indication, wherein the VMR configuration includes one or more operating parameters associated with performing communication relaying, as described above. In some aspects, the VMR configuration includes one or more operating parameters associated with performing communication relaying.

Process 800 may include additional aspects, such as any single aspect or any combination of aspects described below and/or in connection with one or more other processes described elsewhere herein.

In a first aspect, the one or more operating parameters include a geography-based operating parameter.

In a second aspect, alone or in combination with the first aspect, the one or more operating parameters include a subscription-based operating parameter.

In a third aspect, alone or in combination with one or more of the first and second aspects, the one or more operating parameters include a time-based operating parameter.

In a fourth aspect, alone or in combination with one or more of the first through third aspects, the one or more operating parameters include a speed-based operating parameter.

In a fifth aspect, alone or in combination with one or more of the first through fourth aspects, the VMR configuration further includes one or more regional OAM parameters.

In a sixth aspect, alone or in combination with one or more of the first through fifth aspects, the one or more regional OAM parameters include at least one of an OAM server address, a DNN, or S-NSSAI.

In a seventh aspect, alone or in combination with one or more of the first through sixth aspects, the VMR configuration further includes one or more radio configuration parameters.

In an eighth aspect, alone or in combination with one or more of the first through seventh aspects, the one or more radio configuration parameters include at least one of a frequency band or a cell identifier.

In a ninth aspect, alone or in combination with one or more of the first through eighth aspects, process 800 includes receiving a request for the VMR configuration, wherein the VMR configuration is transmitted based at least in part on receiving the request.

In a tenth aspect, alone or in combination with one or more of the first through ninth aspects, the request is received via a user equipment policy container in a registration request message.

In an eleventh aspect, alone or in combination with one or more of the first through tenth aspects, the request is received via a user equipment policy container in an uplink NAS transport message.

In a twelfth aspect, alone or in combination with one or more of the first through eleventh aspects, the VMR configuration is transmitted in a UE policy part IE, wherein a UE policy part type field of the UE policy part IE includes an indication that the UE policy part IE includes the VMR configuration.

In a thirteenth aspect, alone or in combination with one or more of the first through twelfth aspects, the UE policy part IE is included in a manage UE policy command that is carried in a downlink NAS transport message.

In a fourteenth aspect, alone or in combination with one or more of the first through thirteenth aspects, the VMR configuration is transmitted via an OAM PDU session.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram of an example apparatus 900 for wireless communication. The apparatus 900 may be a wireless communication device (e.g., a UE 120, a base station 110, a relay 310, a relay 410, a relay 505, or the like), or a wireless communication device (e.g., a UE 120, a base station 110, a relay 310, a relay 410, a relay 505, or the like) may include the apparatus 900. In some aspects, the apparatus 900 includes a reception component 902 and a transmission component 904, which may be in communication with one another (for example, via one or more buses and/or one or more other components). As shown, the apparatus 900 may communicate with another apparatus 906 (such as a UE, a base station, or another wireless communication device) using the reception component 902 and the transmission component 904. As further shown, the apparatus 900 may include the communication manager 140. The communication manager 140 may include a communication relaying component 908, among other examples.

In some aspects, the apparatus 900 may be configured to perform one or more operations described herein in connection with FIGS. 5 and 6. Additionally, or alternatively, the apparatus 900 may be configured to perform one or more processes described herein, such as process 700 of FIG. 7. In some aspects, the apparatus 900 and/or one or more components shown in FIG. 9 may include one or more components of the wireless communication device described in connection with FIG. 2. Additionally, or alternatively, one or more components shown in FIG. 9 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 902 may receive communications, such as reference signals, control information, data communications, or a combination thereof, from the apparatus 906. The reception component 902 may provide received communications to one or more other components of the apparatus 900. In some aspects, the reception component 902 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 900. In some aspects, the reception component 902 may include one or more antennas, a modem, a demodulator, a MIMO detector, a receive processor, a controller/processor, a memory, or a combination thereof, of the wireless communication device described in connection with FIG. 2.

The transmission component 904 may transmit communications, such as reference signals, control information, data communications, or a combination thereof, to the apparatus 906. In some aspects, one or more other components of the apparatus 900 may generate communications and may provide the generated communications to the transmission component 904 for transmission to the apparatus 906. In some aspects, the transmission component 904 may perform signal processing on the generated communications (such as filtering, amplification, modulation, digital-to-analog conversion, multiplexing, interleaving, mapping, or encoding, among other examples), and may transmit the processed signals to the apparatus 906. In some aspects, the transmission component 904 may include one or more antennas, a modem, a modulator, a transmit MIMO processor, a transmit processor, a controller/processor, a memory, or a combination thereof, of the wireless communication device described in connection with FIG. 2. In some aspects, the transmission component 904 may be co-located with the reception component 902 in a transceiver.

The reception component 902 may receive a VMR configuration, the VMR configuration including one or more operating parameters associated with performing communication relaying. The communication relaying component 908 may perform communication relaying based at least in part on the one or more operating parameters indicated by the VMR configuration.

The transmission component 904 may transmit a request for the VMR configuration, wherein the VMR configuration is received after transmitting the request.

The communication relaying component 908 may establish an OAM PDU session, wherein the VMR configuration is received via the OAM PDU session.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

FIG. 10 is a diagram of an example apparatus 1000 for wireless communication. The apparatus 1000 may be a network entity, or a network entity may include the apparatus 1000. In some aspects, the apparatus 1000 includes a reception component 1002 and a transmission component 1004, which may be in communication with one another (for example, via one or more buses and/or one or more other components). As shown, the apparatus 1000 may communicate with another apparatus 1006 (such as a UE, a base station, or another wireless communication device) using the reception component 1002 and the transmission component 1004. As further shown, the apparatus 1000 may include the communication manager 150.

In some aspects, the apparatus 1000 may be configured to perform one or more operations described herein in connection with FIGS. 5 and 6. Additionally, or alternatively, the apparatus 1000 may be configured to perform one or more processes described herein, such as process 800 of FIG. 8. In some aspects, the apparatus 1000 and/or one or more components shown in FIG. 10 may include one or more components of the network entity described in connection with FIG. 2. Additionally, or alternatively, one or more components shown in FIG. 10 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1002 may receive communications, such as reference signals, control information, data communications, or a combination thereof, from the apparatus 1006. The reception component 1002 may provide received communications to one or more other components of the apparatus 1000. In some aspects, the reception component 1002 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1000. In some aspects, the reception component 1002 may include one or more antennas, a modem, a demodulator, a MIMO detector, a receive processor, a controller/processor, a memory, or a combination thereof, of the network entity described in connection with FIG. 2.

The transmission component 1004 may transmit communications, such as reference signals, control information, data communications, or a combination thereof, to the apparatus 1006. In some aspects, one or more other components of the apparatus 1000 may generate communications and may provide the generated communications to the transmission component 1004 for transmission to the apparatus 1006. In some aspects, the transmission component 1004 may perform signal processing on the generated communications (such as filtering, amplification, modulation, digital-to-analog conversion, multiplexing, interleaving, mapping, or encoding, among other examples), and may transmit the processed signals to the apparatus 1006. In some aspects, the transmission component 1004 may include one or more antennas, a modem, a modulator, a transmit MIMO processor, a transmit processor, a controller/processor, a memory, or a combination thereof, of the network entity described in connection with FIG. 2. In some aspects, the transmission component 1004 may be co-located with the reception component 1002 in a transceiver.

The reception component 1002 may receive an indication to transmit a VMR configuration for reception by a wireless communication device. The transmission component 1004 may transmit the VMR configuration for reception by the wireless communication device based at least in part on the indication, wherein the VMR configuration includes one or more operating parameters associated with performing communication relaying.

The reception component 1002 may receive a request for the VMR configuration, wherein the VMR configuration is transmitted based at least in part on receiving the request.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

The following provides an overview of some Aspects of the present disclosure:

Aspect 1: A method of wireless communication performed by a wireless communication device, comprising: receiving a VMR configuration, the VMR configuration including one or more operating parameters associated with performing communication relaying; and performing communication relaying based at least in part on the one or more operating parameters indicated by the VMR configuration.

Aspect 2: The method of Aspect 1, wherein the one or more operating parameters include a geography-based operating parameter.

Aspect 3: The method of any of Aspects 1-2, wherein the one or more operating parameters include a subscription-based operating parameter.

Aspect 4: The method of any of Aspects 1-3, wherein the one or more operating parameters include a time-based operating parameter.

Aspect 5: The method of any of Aspects 1-4, wherein the one or more operating parameters include a speed-based operating parameter.

Aspect 6: The method of any of Aspects 1-5, wherein the VMR configuration further includes one or more regional OAM parameters.

Aspect 7: The method of Aspect 6, wherein the one or more regional OAM parameters include at least one of an OAM server address, a DNN, or S-NSSAI.

Aspect 8: The method of any of Aspects 1-7, wherein the VMR configuration further includes one or more radio configuration parameters.

Aspect 9: The method of Aspect 8, wherein the one or more radio configuration parameters include at least one of a frequency band or a cell identifier.

Aspect 10: The method of any of Aspects 1-9, further comprising transmitting a request for the VMR configuration, wherein the VMR configuration is received after transmitting the request.

Aspect 11: The method of Aspect 10, wherein the request is transmitted by including a user equipment policy container in a registration request message.

Aspect 12: The method of any of Aspects 10-11, wherein the request is transmitted by including a user equipment policy container in an uplink NAS transport message.

Aspect 13: The method of any of Aspects 10-12, wherein the VMR configuration is received in a UE policy part IE, wherein a UE policy part type field of the UE policy part IE includes an indication that the UE policy part IE includes the VMR configuration.

Aspect 14: The method of Aspect 13, wherein the UE policy part IE is included in a manage UE policy command that is carried in a downlink NAS transport message.

Aspect 15: The method of any of Aspects 1-14, further comprising establishing an OAM PDU session, wherein the VMR configuration is received via the OAM PDU session.

Aspect 16: The method of Aspect 15, wherein the OAM PDU session is established based at least in part on one or more regional OAM parameters pre-configured on the wireless communication device, wherein the one or more regional OAM parameters include at least one of an OAM server address, a DNN, or S-NSSAI.

Aspect 17: A method of wireless communication performed by a network entity, comprising: receiving an indication to transmit a VMR configuration for reception by a wireless communication device; and transmitting the VMR configuration for reception by the wireless communication device based at least in part on the indication, wherein the VMR configuration includes one or more operating parameters associated with performing communication relaying.

Aspect 18: The method of Aspect 17, wherein the one or more operating parameters include a geography-based operating parameter.

Aspect 19: The method of any of Aspects 17-18, wherein the one or more operating parameters include a subscription-based operating parameter.

Aspect 20: The method of any of Aspects 17-19, wherein the one or more operating parameters include a time-based operating parameter.

Aspect 21: The method of any of Aspects 17-20, wherein the one or more operating parameters include a speed-based operating parameter.

Aspect 22: The method of any of Aspects 17-21, wherein the VMR configuration further includes one or more regional OAM parameters.

Aspect 23: The method of Aspect 22, wherein the one or more regional OAM parameters include at least one of an OAM server address, a DNN, or S-NSSAI.

Aspect 24: The method of any of Aspects 17-23, wherein the VMR configuration further includes one or more radio configuration parameters.

Aspect 25: The method of Aspect 24, wherein the one or more radio configuration parameters include at least one of a frequency band or a cell identifier.

Aspect 26: The method of any of Aspects 17-25, further comprising receiving a request for the VMR configuration, wherein the VMR configuration is transmitted based at least in part on receiving the request.

Aspect 27: The method of Aspect 26, wherein the request is received via a user equipment policy container in a registration request message.

Aspect 28: The method of any of Aspects 26-27, wherein the request is received via a user equipment policy container in an uplink NAS transport message.

Aspect 29: The method of any of Aspects 26-28, wherein the VMR configuration is transmitted in a UE policy part IE, wherein a UE policy part type field of the UE policy part IE includes an indication that the UE policy part IE includes the VMR configuration.

Aspect 30: The method of Aspect 29, wherein the UE policy part IE is included in a manage UE policy command that is carried in a downlink NAS transport message.

Aspect 31: The method of any of Aspects 17-30, wherein the VMR configuration is transmitted via an OAM PDU session.

Aspect 32: An apparatus for wireless communication at a device, comprising a processor; memory coupled with the processor; and instructions stored in the memory and executable by the processor to cause the apparatus to perform the method of one or more of Aspects 1-16.

Aspect 33: A device for wireless communication, comprising a memory and one or more processors coupled to the memory, the one or more processors configured to perform the method of one or more of Aspects 1-16.

Aspect 34: An apparatus for wireless communication, comprising at least one means for performing the method of one or more of Aspects 1-16.

Aspect 35: A non-transitory computer-readable medium storing code for wireless communication, the code comprising instructions executable by a processor to perform the method of one or more of Aspects 1-16.

Aspect 36: A non-transitory computer-readable medium storing a set of instructions for wireless communication, the set of instructions comprising one or more instructions that, when executed by one or more processors of a device, cause the device to perform the method of one or more of Aspects 1-16.

Aspect 37: An apparatus for wireless communication at a device, comprising a processor; memory coupled with the processor; and instructions stored in the memory and executable by the processor to cause the apparatus to perform the method of one or more of Aspects 17-31.

Aspect 38: A device for wireless communication, comprising a memory and one or more processors coupled to the memory, the one or more processors configured to perform the method of one or more of Aspects 17-31.

Aspect 39: An apparatus for wireless communication, comprising at least one means for performing the method of one or more of Aspects 17-31.

Aspect 40: A non-transitory computer-readable medium storing code for wireless communication, the code comprising instructions executable by a processor to perform the method of one or more of Aspects 17-31.

Aspect 41: A non-transitory computer-readable medium storing a set of instructions for wireless communication, the set of instructions comprising one or more instructions that, when executed by one or more processors of a device, cause the device to perform the method of one or more of Aspects 17-31.

The foregoing disclosure provides illustration and description but is not intended to be exhaustive or to limit the aspects to the precise forms disclosed. Modifications and variations may be made in light of the above disclosure or may be acquired from practice of the aspects.

Further disclosure is included in the appendix. The appendix is provided as an example only and is to be considered part of the specification. A definition, illustration, or other description in the appendix does not supersede or override similar information included in the detailed description or figures. Furthermore, a definition, illustration, or other description in the detailed description or figures does not supersede or override similar information included in the appendix. Furthermore, the appendix is not intended to limit the disclosure of possible aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A wireless communication device for wireless communication, comprising:
a memory; and
one or more processors, coupled to the memory, configured to:
receive a vehicle-mounted relay (VMR) configuration, the VMR configuration including one or more operating parameters associated with performing communication relaying; and
perform communication relaying based at least in part on the one or more operating parameters indicated by the VMR configuration.

2. The wireless communication device of claim 1, wherein the one or more operating parameters include a geography-based operating parameter.

3. The wireless communication device of claim 1, wherein the one or more operating parameters include a subscription-based operating parameter.

4. The wireless communication device of claim 1, wherein the one or more operating parameters include a time-based operating parameter.

5. The wireless communication device of claim 1, wherein the one or more operating parameters include a speed-based operating parameter.

6. The wireless communication device of claim 1, wherein the VMR configuration further includes one or more regional operations, administration, and maintenance (OAM) parameters.

7. The wireless communication device of claim 6, wherein the one or more regional OAM parameters include at least one of an OAM server address, a data network name (DNN), or single network slice selection assistance information (S-NSSAI).

8. The wireless communication device of claim 1, wherein the VMR configuration further includes one or more radio configuration parameters.

9. The wireless communication device of claim 8, wherein the one or more radio configuration parameters include at least one of a frequency band or a cell identifier.

10. The wireless communication device of claim 1, wherein the one or more processors are further to transmit a request for the VMR configuration, wherein the VMR configuration is received after transmitting the request.

11. The wireless communication device of claim 10, wherein the request is transmitted by including a user equipment policy container in a registration request message.

12. The wireless communication device of claim 10, wherein the request is transmitted by including a user equipment policy container in an uplink non-access stratum (NAS) transport message.

13. The wireless communication device of claim 10, wherein the VMR configuration is received in a user equipment (UE) policy part information element (IE), wherein a UE policy part type field of the UE policy part IE includes an indication that the UE policy part IE includes the VMR configuration.

14. The wireless communication device of claim 13, wherein the UE policy part IE is included in a manage UE policy command that is carried in a downlink non-access stratum (NAS) transport message.

15. The wireless communication device of claim 1, wherein the one or more processors are further to establish an operations, administration, and maintenance (OAM) packet data unit (PDU) session, wherein the VMR configuration is received via the OAM PDU session.

16. The wireless communication device of claim 15, wherein the OAM PDU session is established based at least in part on one or more regional OAM parameters pre-configured on the wireless communication device, wherein the one or more regional OAM parameters include at least one of an OAM server address, a data network name (DNN), or single network slice selection assistance information (S-NSSAI).

17. A network entity for wireless communication, comprising:
a memory; and
one or more processors, coupled to the memory, configured to:
receive an indication to transmit a vehicle-mounted relay (VMR) configuration for reception by a wireless communication device; and
transmit the VMR configuration for reception by the wireless communication device based at least in part on the indication,
wherein the VMR configuration includes one or more operating parameters associated with performing communication relaying.

18. The network entity of claim 17, wherein the one or more operating parameters include at least one of a geography-based operating parameter, a subscription-based operating parameter, time-based operating parameter, or a speed-based operating parameter.

19. The network entity of claim 17, wherein the VMR configuration further includes one or more regional operations, administration, and maintenance (OAM) parameters.

20. The network entity of claim 19, wherein the one or more regional OAM parameters include at least one of an OAM server address, a data network name (DNN), or single network slice selection assistance information (S-NSSAI).

21. The network entity of claim 17, wherein the VMR configuration further includes one or more radio configuration parameters.

22. The network entity of claim 21, wherein the one or more radio configuration parameters include at least one of a frequency band or a cell identifier.

23. The network entity of claim 17, wherein the one or more processors are further to receive a request for the VMR configuration, wherein the VMR configuration is transmitted based at least in part on receiving the request.

24. The network entity of claim 23, wherein the request is received via a user equipment policy container in a registration request message.

25. The network entity of claim 23, wherein the request is received via a user equipment policy container in an uplink non-access stratum (NAS) transport message.

26. The network entity of claim 23, wherein the VMR configuration is transmitted in a user equipment (UE) policy part information element (IE), wherein a UE policy part type field of the UE policy part IE includes an indication that the UE policy part IE includes the VMR configuration.

27. The network entity of claim 26, wherein the UE policy part IE is included in a manage UE policy command that is carried in a downlink non-access stratum (NAS) transport message.

28. The network entity of claim 17, wherein the VMR configuration is transmitted via an operations, administration, and maintenance (OAM) packet data unit (PDU) session.

29. A method of wireless communication performed by a wireless communication device, comprising:
receiving a vehicle-mounted relay (VMR) configuration, the VMR configuration including one or more operating parameters associated with performing communication relaying; and
performing communication relaying based at least in part on the one or more operating parameters indicated by the VMR configuration.

30. A method of wireless communication performed by a network entity, comprising:
receiving an indication to transmit a vehicle-mounted relay (VMR) configuration for reception by a wireless communication device; and
transmitting the VMR configuration for reception by the wireless communication device based at least in part on the indication,
wherein the VMR configuration includes one or more operating parameters associated with performing communication relaying.
